(19) United States
(12) Patent Application Publication
(10) Pub. No.: US 2026/0196198 A1
(43) Pub. Date: Jul. 9, 2026

(54) ELECTRONIC PERCUSSION INSTRUMENT, WIRELESS COMMUNICATION DEVICE, STRIKE PROCESSING METHOD, AND NON-TRANSITORY COMPUTER-READABLE RECORDING MEDIUM

(71) Applicant: Roland Corporation, Shizuoka (JP)

(72) Inventors: Ryo Takasaki, Hamamatsu (JP); Toshiharu Kimura, Hamamatsu (JP); Yoshinori Kusumoto, Shizuoka (JP)

(73) Assignee: Roland Corporation, Shizuoka (JP)

(21) Appl. No.: 19/389,081

(22) Filed: Nov. 14, 2025

(30) Foreign Application Priority Data
Jan. 6, 2025 (JP) 2025-001765

(51) Int. Cl. G10H 3/14; G10H 1/00

(52) U.S. Cl. CPC G10H 3/146; G10H 1/0083; G10H 2230/035

(57) ABSTRACT

In an electronic drum, a power saving transition level when transitioning to a power saving mode is stored, a level when returning to a normal mode is calculated according to an estimated envelope based on the power saving transition level and a power saving duration from the power saving mode to returning to the normal mode, and a strike processing is performed based on the calculated level when returning to the normal mode. Thus, even immediately after returning from the power saving mode to the normal mode, a level of a strike envelope can be calculated using the level when returning to the normal mode calculated from the estimated envelope, and the strike processing can be appropriately performed by using the calculated level of the strike envelope.

### CROSS-REFERENCE TO RELATED APPLICATION

This application claims the priority benefit of Japan application serial no. 2025-001765, filed on Jan. 6, 2025. The entirety of the above-mentioned patent application is hereby incorporated by reference herein and made a part of this specification.

### BACKGROUND

### Technical Field

The disclosure relates to an electronic percussion instrument, a wireless communication device, a strike processing method, and a strike processing program.

### Related Art

Patent Document 1 (Japanese Patent Application Laid-Open No. H3-269577) discloses an electronic musical instrument that performs a processing such as strike detection using an envelope created based on a strike signal detected upon striking a pad Pi. In addition, Patent Document 2 (U.S. Pat. No. 12,033,604) discloses an electronic musical instrument that transitions to a “sleep mode” in which power supply to parts such as an analog circuit is cut off to restrict functions thereof after executing a processing related to detected strikes.

In the electronic musical instrument of Patent Document 2, in the case of performing the processing related to strikes based on an envelope using the method of Patent Document 1, since the parts of the electronic musical instrument have restricted functions during the power saving mode, strike signals cannot be detected and the envelope cannot be created during the power saving mode. As a result, in the case where the electronic musical instrument returns from the power saving mode upon strike, even if a strike signal is detected, it is not possible to determine whether the strike signal is a signal immediately after the strike or is a signal detected due to reverberation of vibration after the strike, and the processing related to strikes cannot be executed accurately.

### SUMMARY

An electronic percussion instrument of an embodiment of the disclosure includes a processing part configured to perform a processing related to a strike based on a level of a strike envelope which is an envelope set based on a detected strike signal. The electronic percussion instrument further includes a power saving transition level storing part and a return estimated level calculating part. The power saving transition level storing part is configured to store a power saving transition level which is a level of the strike envelope at a time of transitioning from a normal mode to a power saving mode having a power consumption lower than the normal mode. The return estimated level calculating part is configured to calculate a level at a time of returning from the power saving mode to the normal mode based on an estimated envelope that is set based on the power saving transition level stored in the power saving transition level storing part and estimates an envelope set based on the strike signal. The processing part is configured to perform the processing related to the strike based on the level calculated by the return estimated level calculating part in a case of returning from the power saving mode to the normal mode.

A wireless communication device of an embodiment of the disclosure is connected to the electronic percussion instrument of the disclosure or a sound source device.

A strike processing method of an embodiment of the disclosure is a method including a processing step of performing a processing related to a strike based on a level of a strike envelope which is an envelope set based on a detected strike signal. The strike processing method further includes a power saving transition level storing step and a return estimated level calculating step. In the power saving transition level storing step, a power saving transition level is stored, the power saving transition level being a level of the strike envelope at a time of transitioning from a normal mode to a power saving mode having a power consumption lower than the normal mode. In the return estimated level calculating step, a level at a time of returning from the power saving mode to the normal mode is calculated based on an estimated envelope that is set based on the power saving transition level stored in the power saving transition level storing step and estimates an envelope set based on the strike signal. In the processing step, the processing related to the strike is performed based on the level calculated in the return estimated level calculating step in a case of returning from the power saving mode to the normal mode.

In addition, a strike processing program of an embodiment of the disclosure is a program causing a computer to execute a processing related to a strike based on a level of a strike envelope which is an envelope set based on a detected strike signal. The strike processing program causes the computer to further execute a power saving transition level storing step, a return estimated level calculating step, and a processing step. In the power saving transition level storing step, a power saving transition level is stored, the power saving transition level being a level of the strike envelope at a time of transitioning from a normal mode to a power saving mode having a power consumption lower than the normal mode. In the return estimated level calculating step, a level at a time of returning from the power saving mode to the normal mode is calculated based on an estimated envelope that is set based on the power saving transition level stored in the power saving transition level storing step and estimates an envelope set based on the strike signal. In the processing step, the processing related to the strike is performed based on the level calculated in the return estimated level calculating step in a case of returning from the power saving mode to the normal mode.

### BRIEF DESCRIPTION OF THE DRAWINGS

FIG. 1 is a view showing an appearance of an electronic drum.

FIG. 2A is a block diagram showing electrical configurations of an electronic drum and a sound source device.

FIG. 2B is a diagram schematically showing a coefficient table.

FIG. 3A is a diagram representing a strike signal in the electronic drum in the case of operating with an operation mode constantly in a normal mode.

FIG. 3B is a diagram representing a strike signal and a strike envelope in the electronic drum in the case of operating with the operation mode constantly in the normal mode.

FIG. 4A is a diagram representing a strike signal in the electronic drum of the present embodiment.

FIG. 4B is a diagram representing a strike signal, a strike envelope, and an estimated envelope in the electronic drum of the present embodiment.

FIG. 4C is a diagram illustrating details of the estimated envelope.

FIG. 5 is a functional block diagram of the electronic drum.

FIG. 6 is a flowchart of a main processing.

FIG. 7 is a flowchart of a strike detecting processing.

FIG. 8 is a flowchart of a peak hold processing.

### DESCRIPTION OF THE EMBODIMENTS

Embodiments of the disclosure provide an electronic percussion instrument, a wireless communication device, a strike processing method, and a strike processing program capable of executing an appropriate processing related to strikes even immediately after returning from a power saving mode.

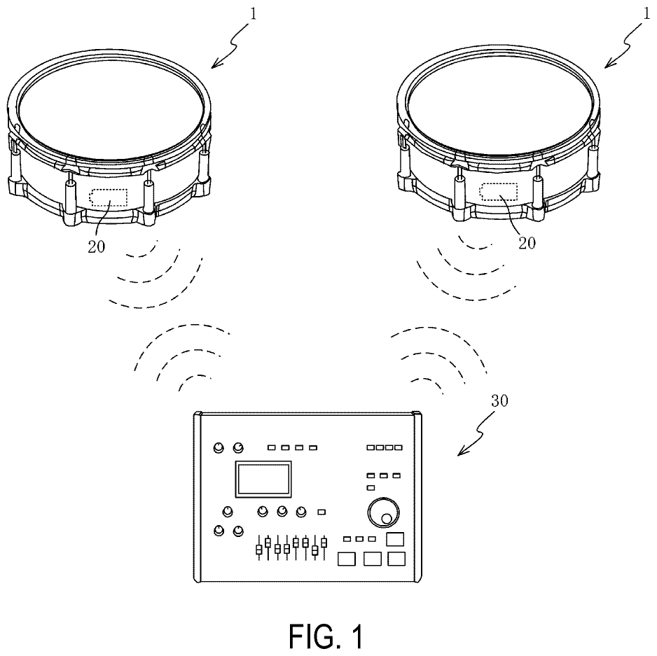

Hereinafter, exemplary embodiments will be described with reference to the accompanying drawings. With reference to FIG. 1, an overview of an electronic drum 1 of the present embodiment will be described. FIG. 1 is a view showing an appearance of the electronic drum 1. The electronic drum 1 is an electronic percussion instrument that transmits performance information corresponding to strikes on a strike surface performed by a user H to a sound source device 30.

The electronic drum 1 is provided with a strike surface which is circular in a top view, and the performance information transmitted from the electronic drum 1 includes detection of strikes on the strike surface (head) or the rim, a strike position and a velocity when the strike surface is struck, a position and a pressure in the case where the strike surface is pressed, and a velocity when the rim is struck, but information relating to strikes on the electronic drum 1 other than the above may also be included. In addition, the electronic drum 1 is provided with a battery 20, and power of each part of the electronic drum 1 is supplied from the battery 20.

The sound source device 30 is an electronic device that outputs (emits) musical sounds based on performance information received from electronic percussion instruments such as the electronic drum 1. In the present embodiment, the electronic drum 1 and the sound source device 30 are connected to each other via wireless communication. In addition, the sound source device 30 is configured to be capable of connecting simultaneously with two or more electronic percussion instruments, and musical sounds based on the performance information received from each electronic percussion instrument are respectively outputted.

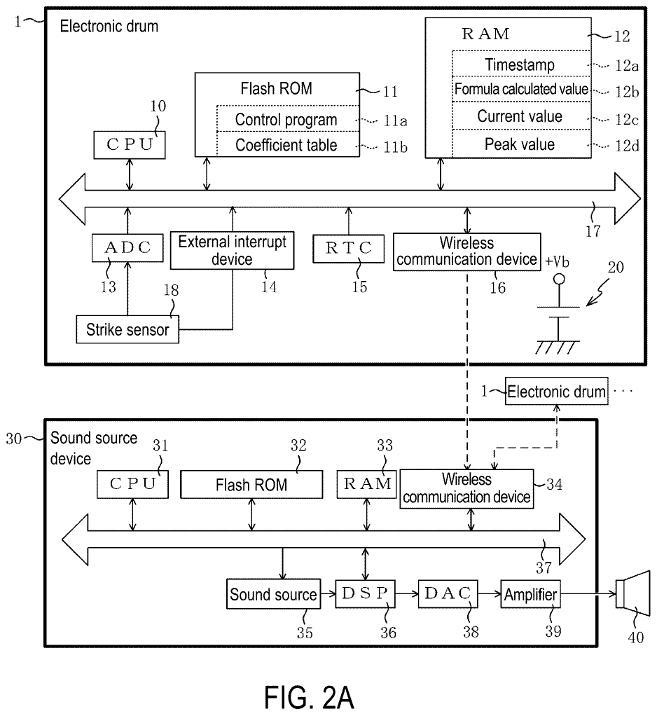

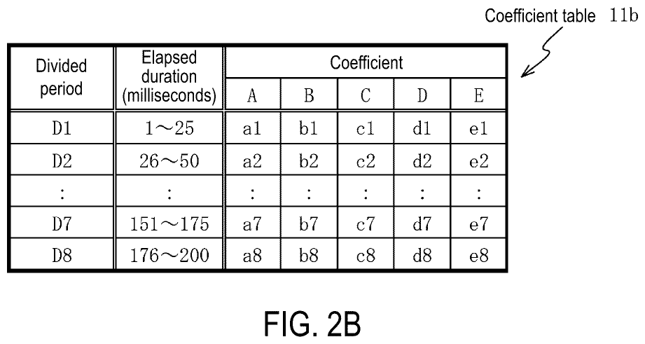

Next, with reference to FIG. 2A, electrical configurations of the electronic drum 1 and the sound source device 30 will be described. FIG. 2A is a block diagram showing the electrical configurations of the electronic drum 1 and the sound source device 30. The electronic drum 1 includes a CPU 10, a flash ROM 11, a RAM 12, an ADC (analog digital converter) 13, an external interrupt device 14, an RTC (real time clock) 15, and a wireless communication device 16, each connected via a bus line 17. In addition, the electronic drum 1 is provided with the battery 20 described above, and a voltage thereof is +Vb (e.g., +3 V).

The CPU 10 is an arithmetic device that controls each part connected by the bus line 17. The flash ROM 11 is a rewritable non-volatile memory. The RAM 12 is a memory to which the CPU 10 stores various work data, flags, etc. in a rewritable manner during program execution. The specific configurations of the flash ROM 11 and the RAM 12 will be described later.

The ADC 13 is a device that converts the voltage of a strike signal Si inputted from a strike sensor 18, which detects strikes on the strike surface, into a digital value. In the case where the voltage (level) of the strike signal Si inputted from the strike sensor 18 is equal to or greater than a threshold level Lt (e.g., 1 V), the external interrupt device 14 outputs an interrupt signal to the CPU 10 indicating that the voltage of the strike signal Si is equal to or greater than the threshold level Lt. That is, in the case where the strike surface is struck and the level of the strike signal Si detected by the strike sensor 18 is equal to or greater than the threshold level Lt, an interrupt signal is transmitted from the external interrupt device 14 to the CPU 10.

The RTC 15 is a device that measures and outputs a current time. The wireless communication device 16 is a device that performs transmission and reception with external devices via wireless communication. Performance information is transmitted to the sound source device 30 via the wireless communication device 16.

In addition, the sound source device 30 includes a CPU 31, a flash ROM 32, a RAM 33, a wireless communication device 34, a sound source 35, and a DSP (digital signal processor) 36, each connected via a bus line 37. A DAC (digital analog converter) 38 is connected to the DSP 36, an amplifier 39 is connected to the DAC 38, and a speaker 40 is connected to the amplifier 39.

The CPU 31 is an arithmetic device that controls each part connected by the bus line 37. The flash ROM 32 is a rewritable non-volatile memory. The RAM 33 is a memory to which the CPU 31 stores various work data, flags, etc. in a rewritable manner during program execution. The wireless communication device 34 is a device that performs transmission and reception with external devices via wireless communication, and performance information is received from the electronic drum 1 via the wireless communication device 34.

The sound source 35 is a device that outputs waveform data corresponding to the performance information received by the wireless communication device 34 and inputted from the CPU 31. The DSP 36 is an arithmetic device for performing arithmetic processing on the waveform data inputted from the sound source 35. The DAC 38 is a conversion device that converts waveform data in digital values inputted from the DSP 36 into waveform data in analog values. The amplifier 39 is an amplification device that amplifies the waveform data inputted from the DAC 38 with a particular gain. The speaker 40 is an output device that outputs analog waveform data amplified by the amplifier 39 as musical sounds.

The electronic drum 1 of the present embodiment is provided with a normal mode and a power saving mode as operation modes, and is operated by switching between these operation modes. Specifically, the normal mode is an operation mode in which power is supplied from the battery 20 to each device provided in the electronic drum 1, and creation of performance information and transmission of created performance information to the sound source device 30 are capable of being executed.

In contrast, the power saving mode is an operation mode that reduces power consumption compared to the normal mode by stopping supply of power from the battery 20 to a part of devices in the electronic drum 1. The power saving mode is also referred to as so-called “sleep mode” or “standby mode”, and in the power saving mode in the present embodiment, supply of power to the ADC 13 and the wireless communication device 16 is stopped. Power is supplied to the RTC 15 in both the normal mode and the power saving mode, and the RTC 15 is configured to be capable of measuring the current time even in the power saving mode. Stop of power supply in the power saving mode is not limited to the ADC 13 and the wireless communication device 16, and devices other than the above may be additionally stopped.

In the electronic drum 1, in the case where an interrupt signal is transmitted from the external interrupt device 14 to the CPU 10 upon strike on the strike surface at a particular level or more, the electronic drum 1 transitions the operation mode to the normal mode, creates performance information based on the strike, and transmits the performance information to the sound source device 30. In the case where the series of processing of creating the performance information and transmitting the performance information to the sound source device 30 is completed, the electronic drum 1 transitions the operation mode to the power saving mode and stops supply of power from the battery 20 to the ADC 13 and the wireless communication device 16. In this manner, in the electronic drum 1, by switching the operation mode between the normal mode and the power saving mode as needed, waste of power of the battery 20 having a limited capacity is suppressed, and the electronic drum 1 can be driven for a long time.

Herein, the performance information transmitted to the sound source device 30 in the electronic drum 1 is created based on a strike envelope HE, which is an envelope created based on the strike signal Si detected from the ADC 13. However, as described above, in the case of the power saving mode, since the ADC 13 is stopped, the strike signal Si becomes unknown during the power saving mode, and thus the strike envelope HE also becomes unknown. As a result, even in the case where the operation mode transitions to the normal mode upon strike on the strike surface, since the strike envelope HE during the power saving mode is unknown, performance information cannot be created immediately after transitioning to the normal mode.

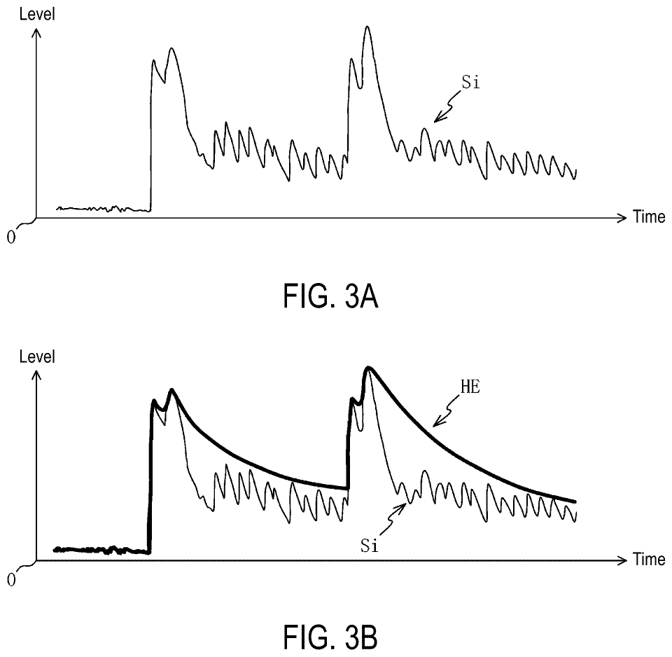

Thus, in the present embodiment, an estimated envelope SE is created based on the strike envelope HE when the operation mode transitions from the normal mode to the power saving mode, and performance information is created using the estimated envelope SE. First, with reference to FIG. 3A and FIG. 3B, a strike signal Si and a strike envelope HE in the electronic drum 1 in the case of operating with the operation mode constantly in the normal mode will be described.

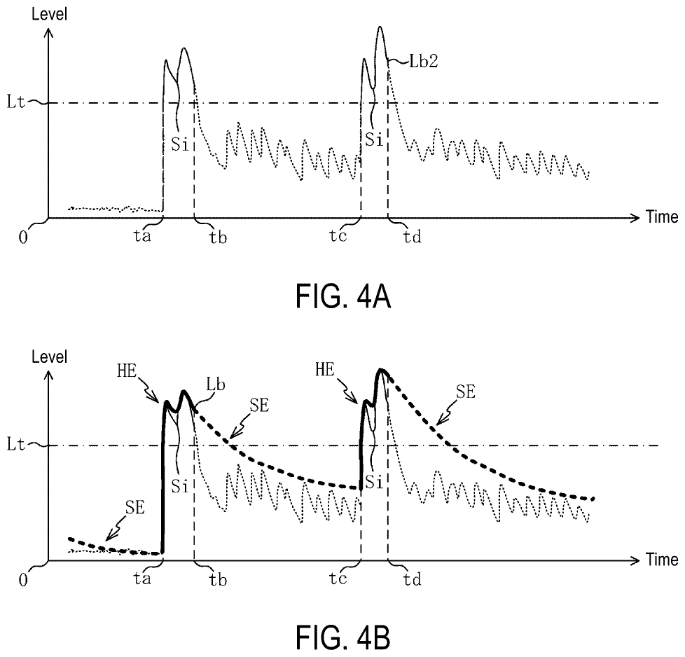

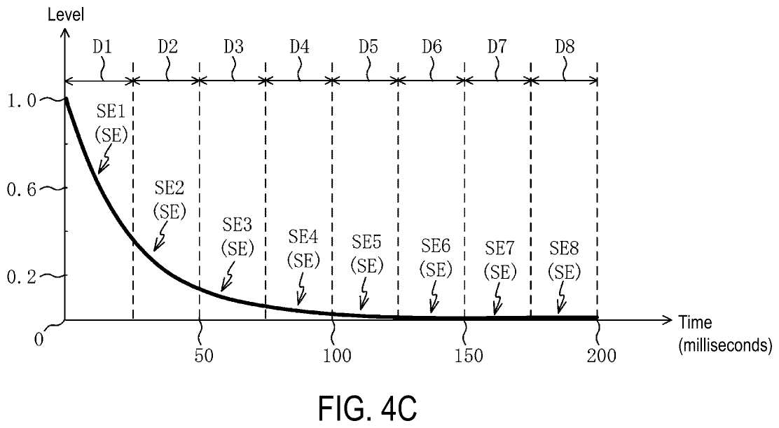

FIG. 3A is a diagram representing a strike signal Si in the electronic drum 1 in the case of operating with the operation mode constantly in the normal mode, and FIG. 3B is a diagram representing a strike signal Si and a strike envelope HE in the electronic drum 1 in the case of operating with the operation mode constantly in the normal mode. In FIG. 3A and FIG. 3B, the vertical axis represents the level of the strike signal Si or the strike envelope HE, and the horizontal axis represents time. The same applies to FIG. 4A and FIG. 4B to be described later.

In the case of operating with the operation mode constantly in the normal mode, since the ADC 13 is also constantly operating, as shown in FIG. 3A, a strike signal Si corresponding to the strike on the strike surface is constantly inputted from the ADC 13. Based on such a strike signal Si, a strike envelope HE as shown in FIG. 3B is created. Specifically, taking the level of the strike signal Si detected at a time t as Si(t), and the level of the strike envelope HE at a time t−1, which is one time unit before the time t, as HE(t−1), the level HE(t) of the strike envelope HE at the time t is calculated according to Mathematical Formula 1 and Mathematical Formula 2.

$$\begin{matrix}[ Math . 1 ] & \\ Ht = HE ( t - 1 ) * 0.99 & ( Mathematical Formula 1 )\end{matrix}$$

$$HE ( t ) = max ( Ht , Si ( t ) ) \qquad ( Mathematical Formula 2 )$$

That is, the level HE(t) of the strike envelope HE at the time t is specifically set as the larger value of a formula calculated value Ht, which is a value obtained by multiplying the level HE(t−1) by 0.99, and the level Si(t). In the case where the calculated level HE(t) is 1.5 times or more the level HE(t−1), it is determined that a strike has been detected, and this detection is set in the performance information and transmitted to the sound source device 30.

Hereinafter, the series of processing, including calculating the level HE(t) based on the strike signal Si detected by the ADC 13, detecting a strike using the calculated level HE(t), creating performance information in which this detection result is set, and transmitting the created performance information to the sound source device 30, will be referred to as “strike processing”.

The coefficient by which the level HE(t−1) is multiplied in Mathematical Formula 1 is not limited to “0.99”, and may also be a value other than 0.99 as long as it is a value greater than 0 and smaller than 1. For example, the coefficient by which the level HE(t−1) is multiplied may also be set according to the characteristics of the strike surface or the performance of the strike sensor 18 in the electronic percussion instrument to be struck. In addition, when determining detection of a strike, the magnification for comparing the level HE(t) and the level HE(t−1) is not limited to 1.5, and may also be a value other than 1.5 as long as it is a value greater than 1.

In this manner, in the case of operating with the operation mode constantly in the normal mode, since the ADC 13 is also constantly operating, the strike signal Si is constantly detected, and the strike envelope HE is also constantly calculated according to Mathematical Formula 1 and Mathematical Formula 2. The strike processing described above is performed using the strike envelope HE that is constantly calculated.

In contrast, a strike signal Si and an envelope for creating performance information in the electronic drum 1 of the present embodiment, which is switched between the normal mode and the power saving mode, will be described with reference to FIG. 4A and FIG. 4B.

FIG. 4A is a diagram representing a strike signal in the electronic drum 1 of the present embodiment. In FIG. 4A and FIG. 4B to be described later, the strike signal Si detected by the ADC 13 is represented by a solid line, and the strike signal Si that is detected by the strike sensor 18 but is not detected by the ADC 13 to which power supply is stopped in the power saving mode is represented by a broken line.

As shown in FIG. 4A, in response to the level detected by the strike sensor 18 at a time ta becoming equal to or greater than the threshold level Lt, the operation mode returns from the power saving mode to the normal mode. Accordingly, power is supplied to the ADC 13, detection of the strike signal Si by the ADC 13 is started, and the strike processing is performed. At a time tb at which the strike processing is completed, the operation mode transitions again to the power saving mode. Thereafter, the operation mode returns from the power saving mode to the normal mode at a time tc, and transitions to the power saving mode at a time td.

That is, the strike envelope HE is capable of being created during the period from the time ta to the time tb and the period from the time tc to the time td, in which the strike signal Si is capable of being detected by the ADC 13, but before the time ta and during the period from the time tb to the time tc, the strike signal Si cannot be detected by the ADC 13 due to the power saving mode, and the strike envelope HE cannot be created according to Mathematical Formula 1 and Mathematical Formula 2 above.

Accordingly, at the time ta and the time tc, at which the strike signal Si becomes equal to or greater than the threshold level Lt, it is not possible to determine whether the strike signal Si is a signal immediately after the strike or is a signal detected due to reverberation of vibration after the strike, and strike detection cannot be appropriately executed. That is, the strike processing is not appropriately performed.

Thus, in the present embodiment, the level when returning to the normal mode is calculated from an estimated envelope SE based on the strike envelope HE when transitioning from the normal mode to the power saving mode to perform the strike processing. The estimated envelope SE will be described with reference to FIG. 4B and FIG. 4C.

FIG. 4B is a diagram representing a strike signal Si, a strike envelope HE, and an estimated envelope SE in the electronic drum 1 of the present embodiment. The estimated envelope SE is obtained by estimating an envelope of the strike signal Si at a timing at which the strike signal Si cannot be detected by the ADC 13 during the power saving mode.

In FIG. 4B, the estimated envelope SE is created during the power saving mode, i.e., before the time ta, during the period from the time tb to the time tc, and after the time td. In the figure, the estimated envelope SE is represented by a thick broken line. The estimated envelope SE is set in a manner in which the starting point thereof is set as a power saving transition level Lb, and the level gradually decreases from the power saving transition level Lb.

The estimated envelope SE is configured by further approximating an exponential function, which approximates the envelope of the strike signal Si, with a fourth-degree polynomial (details thereof will be described later). By inputting the starting time point of the estimated envelope SE, i.e., a power saving duration, which is a duration from the transition to the power saving mode to the return to the normal mode, into such a polynomial, the magnitude of the level corresponding to that timing is acquired (calculated). That is, the magnitude of the level at the inputted power saving duration can be acquired from the estimated envelope SE, regardless of whether the strike signal Si can or cannot be detected by the ADC 13.

At the time tc at which the operation mode switches from the power saving mode to the normal mode, since the strike signal Si cannot be detected by the ADC 13 at a time (tc−1) which is a timing immediately before, the level HE(t) of the strike envelope HE according to Mathematical Formula 1 and Mathematical Formula 2 above, i.e., HE(tc), cannot be calculated. Thus, a level SE(tc−1) at the time (tc−1) is acquired from an estimated envelope SE using the power saving transition level Lb, which is the level of the strike envelope HE when transitioning to the power saving mode, i.e., at the time tb. HE(tc) is calculated using the level SE(tc−1), and the strike processing is performed using the calculated HE(tc).

More specifically, the level SE(tc−1) acquired from the estimated envelope SE using the power saving transition level Lb is used in place of HE(t−1) in Mathematical Formula 1 above to calculate the formula calculated value Ht. Details of acquiring the level SE(tc−1) from the estimated envelope SE will be described later with reference to FIG. 4C.

Using the formula calculated value Ht as calculated, the level HE(t) (i.e., level HE(tc)) of the strike envelope HE at the time tc is calculated according to Mathematical Formula 2. Then, the strike processing using the calculated level HE(tc) is performed. For example, by confirming whether the level HE(tc) at the time tc of returning to the normal mode is 1.5 times the level SE(tc−1) from the estimated envelope SE at the time tc−1 immediately before returning to the normal mode, it is possible to confirm whether a strike has been detected at the time tc immediately after returning to the normal mode. In this manner, by using the level calculated from the estimated envelope SE, the strike processing can be appropriately performed even immediately after returning from the power saving mode to the normal mode.

Next, with reference to FIG. 4C, details of the estimated envelope SE used in the strike processing will be described. FIG. 4C is a diagram illustrating details of the estimated envelope SE. The estimated envelope SE is configured based on an approximate exponential function which is an exponential function approximating the envelope of the strike signal Si. More specifically, the estimated envelope SE is obtained by approximating with a fourth-degree polynomial for each period obtained by dividing a progression of the approximate exponential function during a period of 0 to 200 milliseconds into 8 periods.

First, an approximate exponential function that approximates the envelope of the strike signal Si is set. The coefficients set in the approximate exponential function are set according to various mathematical approximation procedures based on the envelope to be approximated. A progression of the set exponential function during the period of 0 to 200 milliseconds is calculated.

Then, divided periods D1 to D8 are set by dividing the period of 0 to 200 milliseconds into 8 periods. Specifically, the period of 0 to 25 milliseconds is set as the divided period D1, the period of 26 to 50 milliseconds is set as the divided period D2, the period of 51 to 75 milliseconds is set as the divided period D3, the period of 76 to 100 milliseconds is set as the divided period D4, the period of 101 to 125 milliseconds is set as the divided period D5, the period of 126 to 150 milliseconds is set as the divided period D6, the period of 151 to 175 milliseconds is set as the divided period D7, and the period of 176 to 200 milliseconds is set as the divided period D8. That is, the divided periods D1 to D8 are each set to a same duration (25 milliseconds).

Hereinafter, in the case of not particularly distinguishing among the divided periods D1 to D8, the divided periods D1 to D8 will be referred to as “divided period Dn”. In such “Dn”, an integer from 1 to 8 is specified as “n”. In the case where “n” is 1, it represents “divided period D1”, and in the case where “n” is 4, it represents “divided period D4”. The same applies to “n” in “SEn(t)” to be described later.

Then, for each divided period Dn, a fourth-degree polynomial that approximates the progression of the approximate exponential function in the corresponding period is set. Specifically, a polynomial SEn(t) in the divided period Dn in the case where the power saving duration from 0 seconds is t is set according to Mathematical Formula 3.

$$\begin{matrix}[ Math . 2 ] & \\ SEn ( t ) = A \cdot {t}^{4} + B \cdot {t}^{3} + C \cdot {t}^{2} + D \cdot t + E & ( Mathematical Formula 3 )\end{matrix}$$

For each of the divided periods D1 to D8, coefficients A to E in Mathematical Formula 3 are set according to various mathematical approximation procedures to approximate the envelope of the corresponding divided period. SEn(t) is set such that the maximum value becomes 1.0. Specifically, SEn(t) is set such that the value of SE1(0) in the case where the time of the divided period D1 is “0” becomes “1”. This value of SE1(0) is a value corresponding to the power saving transition level Lb, which is the level when transitioning to the power saving mode. Thus, by multiplying the value of SEn(t) calculated from Mathematical Formula 3 by the power saving transition level Lb, the level of the estimated envelope SE at the power saving duration is calculated.

In the case of returning from the power saving mode to the normal mode at a time t1, to calculate the level of the estimated envelope SE at the time t1, first, the power saving duration from the time of transitioning to the power saving mode to the time t1 is calculated. Next, the divided period Dn corresponding to the calculated power saving duration is specified. Then, coefficients A to E corresponding to the specified divided period Dn are acquired, and by inputting the calculated power saving duration into Mathematical Formula 3 to which the acquired coefficients A to E are applied, a value is calculated, and this calculated value is further multiplied by the power saving transition level Lb to calculate the level of the estimated envelope SE at the time t1.

In the case where the divided period D8 onward, i.e., 200 milliseconds onward is inputted as the power saving duration, 0 is calculated from SEn(t). Accordingly, the level can be calculated from the estimated envelope SE even in the case where a long time has elapsed since transitioning to the power saving mode.

As described above, the estimated envelope SE is set based on an approximate exponential function that approximates the envelope of the strike signal Si. Accordingly, the estimated envelope SE can accurately estimate the envelope of the strike signal Si of which the level attenuates over time. The approximate exponential function is further approximated with a fourth-degree polynomial. Accordingly, exponential calculations, which require relatively long calculation time, can be reduced when calculating the level from the estimated envelope SE, and the level of the estimated envelope can be quickly acquired.

In addition, coefficients A to E in the fourth-degree polynomial are set for each of the divided periods D1 to D8 obtained by dividing the period of 0 to 200 milliseconds in the progression of the approximate exponential function into 8 parts. Thus, since the coefficients A to E can be set for each divided period Dn to approximate the shape of the approximate exponential function corresponding to the period, a fourth-degree polynomial with little error from the approximate exponential function to be approximated can be set in each of the divided periods Dn. Accordingly, an appropriate level can be calculated from the estimated envelope SE throughout the entire period of the divided periods D1 to D8.

In addition, by dividing the period of 0 to 200 milliseconds into 8 parts, each SEn(t) can be approximated more accurately to the approximate exponential function compared to the case of setting the number of divisions of the period of 0 to 200 milliseconds to 7 or less, so a step difference (error) at the connection portion with SEn(t) of adjacent divided periods Dn can be reduced. Accordingly, the estimated envelope SE obtained by connecting each SEn(t) can be configured to exhibit little error with respect to the approximate exponential function.

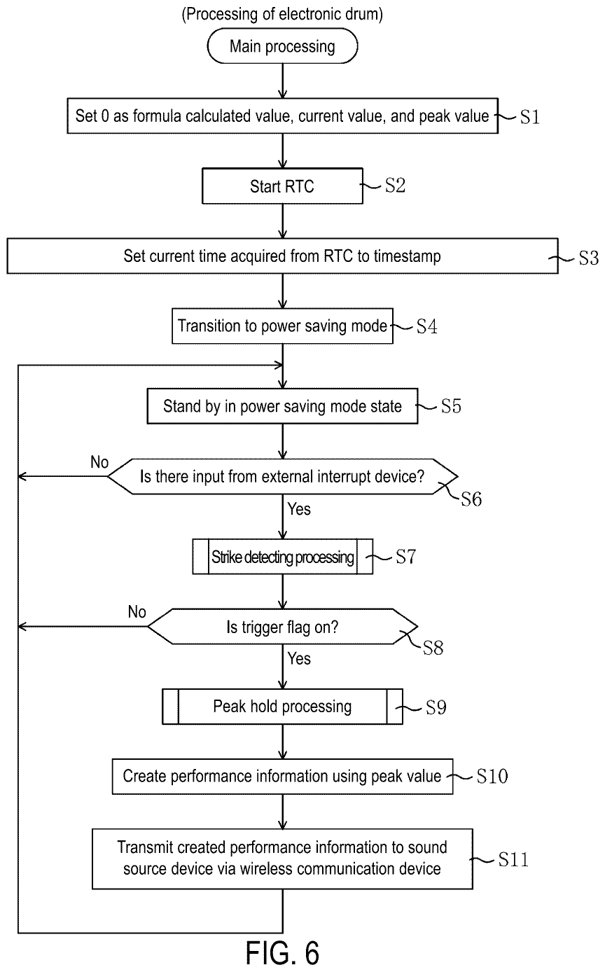

Returning to FIG. 2A, the flash ROM 11 and the RAM 12 of the electronic drum 1 will be described. The flash ROM 11 includes a control program 11a and a coefficient table 11b. Upon execution of the control program 11 a by the CPU 10, a main processing of FIG. 6 is executed. The coefficient table 11b will be described with reference to FIG. 2B.

FIG. 2B is a diagram schematically representing the coefficient table 11b. As shown in FIG. 2B, the coefficient table 11b stores the coefficients A to E to be applied to Mathematical Formula 3 above for each divided period Dn. The divided period Dn corresponding to the power saving duration from the power saving mode is specified, and the coefficients A to E corresponding to the specified divided period Dn are acquired from the coefficient table 11b.

Returning to FIG. 2A, the RAM 12 includes a timestamp 12a in which a time acquired from the RTC 15 is set, a formula calculated value 12b in which calculation results of Mathematical Formula 2 and Mathematical Formula 3 above are stored, a current value 12c, and a peak value 12d. The current value 12c stores the larger level of the level of the strike signal Si detected from the ADC 13 and the level of the strike envelope HE or the estimated envelope SE. In addition, the peak value 12d stores the maximum level among the levels stored in the current value 12c during a particular scan time.

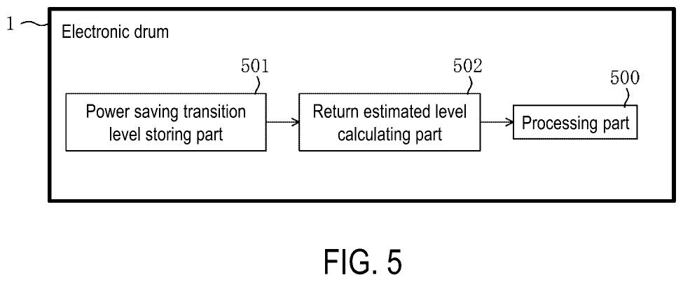

Next, functions of the electronic drum 1 will be described with reference to FIG. 5. FIG. 5 is a functional block diagram of the electronic drum 1. As shown in FIG. 5, the electronic drum 1 includes a processing part 500, a power saving transition level storing part 501, and a return estimated level calculating part 502.

The processing part 500 is a part that performs the strike processing based on the level of the strike envelope HE set based on the detected strike signal Si, and is realized by the CPU 10. The power saving transition level storing part 501 is a part that stores the power saving transition level Lb when transitioning from the normal mode to the power saving mode, and is realized by the CPU 10 and the RAM 12.

The return estimated level calculating part 502 is a part that calculates the level when returning from the power saving mode to the normal mode based on the estimated envelope SE set based on the power saving transition level Lb stored in the power saving transition level storing part 501, and is realized by the CPU 10. In addition, in the processing part 500, in the case of returning from the power saving mode to the normal mode, the strike processing is performed based on the level calculated by the return estimated level calculating part 502.

In the case where the electronic drum 1 is in the power saving mode, the strike envelope HE becomes unknown because the strike signal Si is not detected, and the strike envelope HE immediately after returning from the power saving mode to the normal mode also becomes unknown, so the strike processing based on the strike envelope HE cannot be accurately executed.

In this regard, since the estimated envelope SE is set based on the power saving transition level Lb when transitioning from the normal mode to the power saving mode, even in the case where the strike signal Si during the power saving mode is not detected, the level of the envelope based on the strike signal Si corresponding to that timing can be calculated from the estimated envelope SE. By performing the strike processing based on the level calculated from the estimated envelope SE in this manner, the strike processing can be appropriately executed even immediately after returning from the power saving mode to the normal mode.

Next, with reference to FIG. 6 to FIG. 9, processings executed by the CPU 10 of the electronic drum 1 will be described. FIG. 6 is a flowchart of the main processing. The main processing is a processing executed after power-on of the electronic drum 1.

In the main processing, first, 0 is set as an initial value respectively to the formula calculated value 12b, the current value 12c, and the peak value 12d (S1). After the processing of S1, the RTC 15 is started (S2), and a current time acquired from the RTC 15 is set as an initial value to the timestamp 12a (S3). After the processing of S3, the operation mode transitions to the power saving mode (S4).

After the processing of S4, the operation stands by in the power saving mode state (S5). In the case where the processing of S5 is executed after processings of S6, S8, and S11 to be described later, with the operation mode being the normal mode, the processing of S5 is executed after transitioning to the power saving mode.

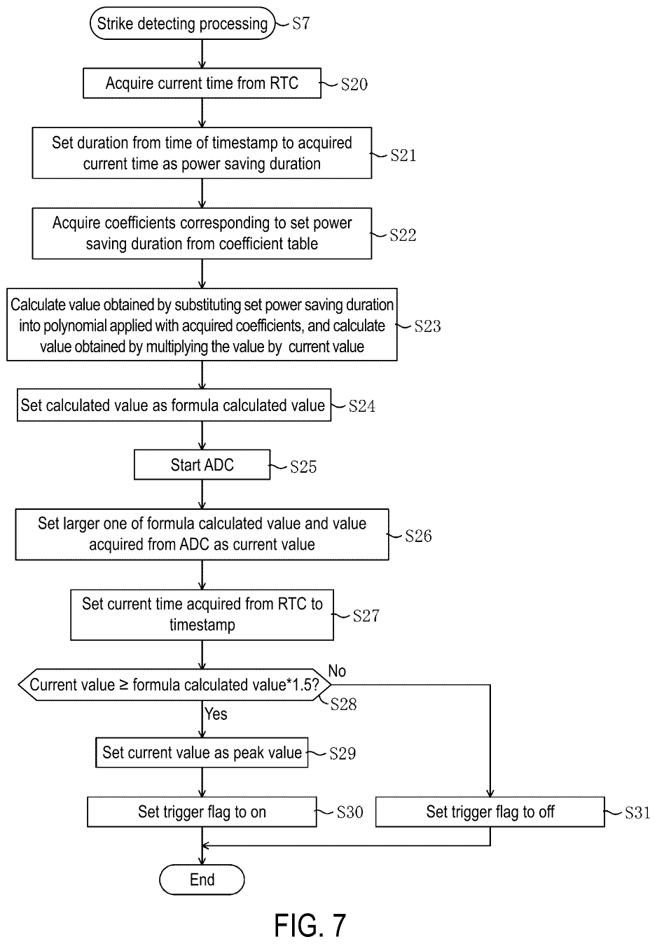

After the processing of S5, it is confirmed whether an interrupt signal has been inputted from the external interrupt device 14 (S6). In the processing of S6, in the case of confirming that an interrupt signal has been inputted from the external interrupt device 14 (S6: Yes), after switching the operation mode from the power saving mode to the normal mode, a strike detecting processing (S7) is executed. Herein, with reference to FIG. 7, the strike detecting processing will be described.

FIG. 7 is a flowchart of the strike detecting processing. In the strike detecting processing, first, a current time is acquired from the RTC 15 (S20). After the processing of S20, a duration from the time stored in the timestamp 12a to the current time acquired from the RTC 15 in the processing of S20 (specifically, to the time of returning from the power saving mode to the normal mode) is set as a power saving duration (S21).

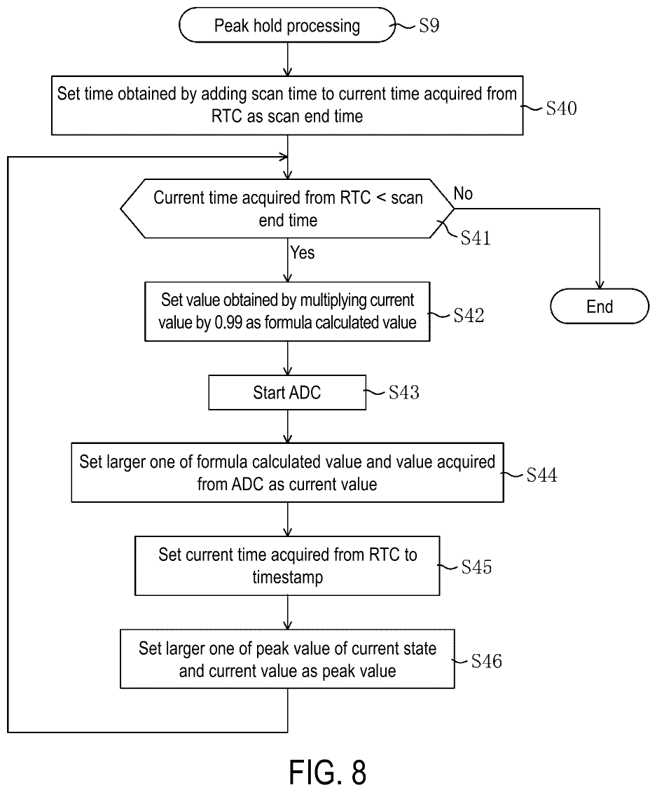

After the processing of S21, coefficients A to E of the polynomial corresponding to the set power saving duration are acquired from the coefficient table 11b (S22). After the processing of S22, the coefficients A to E acquired in the processing of S22 are applied to the polynomial of Mathematical Formula 3, and a value (i.e., the value of SEn(t) described above) obtained by substituting the power saving duration set in the processing of S21 into the polynomial is calculated, and a value obtained by multiplying that value by the value of the current value 12c is calculated (S23). The value of the current value 12c to be multiplied in the processing of S23 corresponds to the power saving transition level Lb described above (details thereof will be described later with reference to FIG. 8).

In the processing of S23, calculation of the values is performed using fixed-point. Accordingly, since the computational load on the CPU 10 can be reduced compared to the case of calculating using floating-point, calculation of the values can be performed quickly.

After the processing of S23, the value (level) calculated in the processing of S23 is set as the formula calculated value 12b (S24). After the processing of S24, the ADC 13 is started (S25), and the larger one of the level stored in the formula calculated value 12b and the level of a strike signal Si acquired from the ADC 13 is set as the current value 12c (S26). Accordingly, the level of the estimated envelope SE is stored in the current value 12c. After the processing of S26, the current time acquired from the RTC 15 is set to the timestamp 12a (S27).

After the processing of S27, it is confirmed whether the level stored in the current value 12c is 1.5 times or more the level stored in the formula calculated value 12b (S28). Since the level of the estimated envelope SE when returning to the normal mode is stored in the formula calculated value 12b according to the processing of S24, in the processing of S28, it is confirmed whether the level of the strike signal Si acquired from the ADC 13 stored in the current value 12c according to the processing of S26 (or the larger one of the levels stored in the formula calculated value 12b) is 1.5 times or more the level of the estimated envelope SE when returning to the normal mode.

In the processing of S28, in the case of confirming that the level stored in the current value 12c is 1.5 times or more the level stored in the formula calculated value 12b (S28: Yes), the value of the current value 12c is set as the peak value 12d (S29), and the trigger flag is set to on (S30). The trigger flag is a flag that indicates whether to detect the peak of the strike signal Si. In the case where the trigger flag is on, it indicates detecting the peak of the strike signal Si, and in the case of being off, it indicates not detecting the peak of the strike signal Si.

In contrast, in the processing of S28, in the case of confirming that the level stored in the current value 12c is smaller than 1.5 times the level stored in the formula calculated value 12b (S28: No), the trigger flag is set to off (S31). After the processings of S30 and S31, the strike detecting processing is ended.

Returning to FIG. 6, after the strike detecting processing of S7, it is confirmed whether the trigger flag is on (S8). In the processing of S8, in the case of confirming that the trigger flag is on (S8: Yes), a peak hold processing (S9) is executed. Herein, with reference to FIG. 8, the peak hold processing will be described.

FIG. 8 is a flowchart of the peak hold processing. In the peak hold processing, first, a time obtained by adding a scan time (e.g., 2 milliseconds) to the current time acquired from the RTC 15 is set as a scan end time (S40).

After the processing of S40, it is confirmed whether the current time acquired from the RTC 15 falls before the scan end time (S41). In the processing of S41, in the case of confirming that the current time acquired from the RTC 15 falls before the scan end time (S41: Yes), a value obtained by multiplying the level of the current value 12c by 0.99, i.e., the formula calculated value Ht in Mathematical Formula 1 described above, is calculated and set as the formula calculated value 12b (S42). In such a processing of S42, calculation of the value is performed using fixed-point in a manner similar to the processing of S23 described above.

After the processing of S42, the ADC 13 is started (S43), and the larger one of the level of the formula calculated value 12b (i.e., formula calculated value Ht) and the level of the strike signal Si acquired from the ADC 13 is set as the current value 12c (S44). Accordingly, the level of the strike envelope HE is stored in the current value 12c. In the current value 12c in the processing of S23 described above, the level of the strike envelope HE set in the processing of S44, which is the level of the strike envelope HE calculated when transitioning from the normal mode to the power saving mode, is stored. After the processing of S44, the current time is acquired from the RTC 15 and set in the timestamp 12a (S45).

After the processing of S45, the larger one of the level of the current peak value 12d and the level of the current value 12c is set (updated) as the peak value 12d (S46). After the processing of S46, the processings from S41 onward are repeated. In the processing of S41, in the case of confirming that the current time acquired from the RTC 15 falls at or after the scan end time (S41: No), the peak hold processing is ended.

In the peak hold processing, by repeating the processing of S46 until the scan end time arrives, the maximum level in the strike envelope HE, i.e., the peak value of the strike envelope HE, is detected and set as the peak value 12d.

Returning to FIG. 6, after the peak hold processing of S9, performance information is created using the level of the peak value 12d (S10). Specifically, the performance information created in the processing of S10 includes indication that the strike surface has been struck, and the strike position of the strike surface and the velocity at the time of strike calculated according to a conventional method using the level of the peak value 12d.

After the processing of S10, the created performance information is transmitted to the sound source device 30 via the wireless communication device 16 (S11). Using the performance information transmitted according to the processing of S11, the sound source device 30 creates waveform data with the sound source 35 and the DSP 36, and by inputting the created waveform data to the DAC 38, the amplifier 39, and the speaker 40, musical sounds are emitted. After the processing of S11, the processings of S5 onward are repeated.

Although the disclosure has been described above based on the embodiment, it can be easily inferred that various improvements and modifications are possible.

In the above embodiment, in Mathematical Formula 3, the level of the estimated envelope SE is calculated using a fourth-degree polynomial that further approximates the approximate exponential function, but the disclosure is not limited thereto. The level of the estimated envelope SE may also be calculated using a polynomial of degree 3 or lower or a polynomial of degree 5 or higher that further approximates the approximate exponential function, the level of the estimated envelope SE may also be calculated using a monomial that further approximates the approximate exponential function, or the level of the estimated envelope SE may also be calculated by further approximating the approximate exponential function with a function other than a polynomial or a monomial.

In addition, the level of the estimated envelope SE may also be directly acquired from the approximate exponential function, the level of the estimated envelope SE may also be calculated by approximating the estimated envelope SE with a function other than an exponential function, such as a logarithmic function or a trigonometric function, or the level of the estimated envelope SE may also be calculated from a polynomial or a monomial that further approximates a function such as a logarithmic function or a trigonometric function approximating the estimated envelope SE.

In the above embodiment, the period of 0 to 200 milliseconds in the progression of the approximate exponential function is divided into 8 divided periods Dn, i.e., divided periods D1 to D8, and a polynomial is provided for each of the divided periods D1 to D8, but the disclosure is not limited thereto. The period of the progression of the approximate exponential function may also be 200 milliseconds or more, or may also be 200 milliseconds or less. In addition, the disclosure is not limited to dividing the period into 8 divided periods Dn, and may also divide the period into 8 or more divided periods Dn, or may also divide the period into 8 or fewer divided periods Dn. Alternatively, without providing the divided periods Dn, the level of the estimated envelope SE for the entire period of 0 to 200 milliseconds may also be calculated according to one polynomial.

In addition, in the above embodiment, the lengths of the divided periods D1 to D8 are all configured to be the same (25 milliseconds), but the disclosure is not limited thereto, and the lengths of the divided periods D1 to D8 may also be configured to be different from each other. For example, in FIG. 4C, more divided periods Dn (e.g., six) may be provided during the period of 0 to 100 milliseconds in which the change in the approximate exponential function is relatively large, and fewer divided periods Dn (e.g., one) may be provided during the period of 100 to 200 milliseconds in which the change in the approximate exponential function is relatively small. Accordingly, the approximate exponential function can be approximated with high accuracy by the polynomial in each divided period Dn, and the number of divided periods Dn can also be less than 8 as in the above embodiment, so the capacity of the coefficient table 11b in which the coefficients of the polynomials are stored can also be reduced.

In addition, in all of the divided periods Dn, the approximate exponential function is approximated by a fourth-degree polynomial, but the disclosure is not limited thereto, and the approximate exponential function may also be approximated by a function different for each divided period Dn. For example, the divided period D1 may be approximated by a sixth-degree polynomial, the divided period D2 may be approximated by a fifth-degree polynomial, the divided period D3 may be approximated by a fourth-degree polynomial, the divided period D4 may be approximated by a third-degree polynomial, the divided period D5 may be approximated by a second-degree polynomial, the divided period D6 may be approximated by a trigonometric function, the divided period D7 may be approximated by a logarithmic function, and the divided period D8 may be approximated by a monomial.

In the above embodiment, in Mathematical Formula 3, the level of the estimated envelope SE is calculated by inputting the power saving duration, but the disclosure is not limited thereto. For example, the current time acquired from the RTC 15 may be inputted in place of the power saving duration, and the level of the estimated envelope SE may be calculated from the inputted current time.

In that case, the time of transitioning to the power saving mode is set in Mathematical Formula 3, and by subtracting the inputted current time (specifically, the time of returning to the normal mode) from the time of transitioning to the power saving mode in Mathematical Formula 3, the power saving duration is calculated in Mathematical Formula 3, and the level of the estimated envelope SE is calculated using the power saving duration.

In the above embodiment, the electronic drum 1 and the sound source device 30 are connected to each other via wireless communication, but the disclosure is not limited thereto, and the electronic drum 1 and the sound source device 30 may also be connected via wired communication. In addition, in the above embodiment, power is supplied to each part of the electronic drum 1 from the battery 20, but the disclosure is not limited thereto, and power may also be supplied to each part of the electronic drum 1 from another power source other than the battery 20.

In addition, in the above embodiment, the electronic drum 1 is configured to include a built-in wireless communication device 16 that wirelessly communicates with the sound source device 30, but the disclosure is not limited thereto. For example, a separate wireless communication device may be connected (externally attached) to the electronic drum 1, and wireless communication with the sound source device 30 may be performed via this wireless communication device. Similarly, in the above embodiment, the sound source device 30 is configured to include a built-in wireless communication device 34, but the disclosure is not limited thereto. For example, a separate wireless communication device may be connected (externally attached) to the sound source device 30, and wireless communication with the electronic drum 1 may be performed via this wireless communication device.

In the above embodiment, the electronic drum 1 is configured to include a built-in strike sensor 18 that detects strikes on the strike surface, but the disclosure is not limited thereto. For example, a separate strike sensor may be connected (externally attached) to the electronic drum 1, and strikes on the strike surface may be detected by this strike sensor.

In the above embodiment, the electronic drum 1 is used as the electronic percussion instrument, but the disclosure is not limited thereto, and another electronic percussion instrument such as electronic cymbals or an electronic conga may also be used. In addition, the control program 11a is configured to be executed by the electronic drum 1, but the disclosure is not limited thereto. For example, the control program 11a may also be configured to be executable by an information processing device (computer) such as a personal computer or a mobile terminal to which a pad capable of detecting a strike signal Si is connected.

What is claimed is:

1. An electronic percussion instrument comprising a processing part configured to perform a processing related to a strike based on a level of a strike envelope which is an envelope set based on a detected strike signal, the electronic percussion instrument further comprising:
a power saving transition level storing part configured to store a power saving transition level which is a level of the strike envelope at a time of transitioning from a normal mode to a power saving mode having a power consumption lower than the normal mode; and
a return estimated level calculating part configured to calculate a level at a time of returning from the power saving mode to the normal mode based on an estimated envelope that is set based on the power saving transition level stored in the power saving transition level storing part and estimates an envelope set based on the strike signal, wherein the processing part is configured to perform the processing related to the strike based on the level calculated by the return estimated level calculating part in a case of returning from the power saving mode to the normal mode.

2. The electronic percussion instrument according to claim 1, further comprising:
a duration calculating part configured to calculate a power saving duration which is a duration from transitioning to the power saving mode to returning to the normal mode, wherein
the return estimated level calculating part is configured to calculate a level at the time of returning from the power saving mode to the normal mode according to the estimated envelope based on the power saving duration calculated by the duration calculating part.

3. The electronic percussion instrument according to claim 1, wherein
a particular period after transitioning to the power saving mode is divided into a plurality of divided periods, and
the estimated envelope is set for each of the divided periods.

4. The electronic percussion instrument according to claim 3, wherein
a same duration is set for each of the divided periods.

5. The electronic percussion instrument according to claim 1, wherein
the estimated envelope is expressed by an exponential function.

6. The electronic percussion instrument according to claim 1, wherein
the estimated envelope is expressed by a function based on a monomial or a polynomial.

7. The electronic percussion instrument according to claim 6, wherein
the monomial or the polynomial is obtained by approximating an exponential function.

8. The electronic percussion instrument according to claim 6, wherein
the monomial or the polynomial is obtained by approximating a logarithmic function or a trigonometric function.

9. A wireless communication device connected to the electronic percussion instrument according to claim 1.

10. A wireless communication device connected to a sound source device connected to the electronic percussion instrument according to claim 1.

11. The wireless communication device of claim 1, wherein the sound source device connected to the electronic percussion instrument via wireless communication.

12. A strike processing method comprising performing a processing related to a strike based on a level of a strike envelope which is an envelope set based on a detected strike signal, the strike processing method further comprising:
storing a power saving transition level which is a level of the strike envelope at a time of transitioning from a normal mode to a power saving mode having a power consumption lower than the normal mode; and
calculating a level at a time of returning from the power saving mode to the normal mode based on an estimated envelope that is set based on the power saving transition level stored and estimates an envelope set based on the strike signal, wherein
the processing related to the strike is performed based on the level at the time of returning from the power saving mode to the normal mode calculated based on the estimated envelope in a case of returning from the power saving mode to the normal mode.

13. The strike processing method of claim 12, further
calculating a power saving duration which is a duration from transitioning to the power saving mode to returning to the normal mode, wherein
the return estimated level calculating part is configured to calculate a level at the time of returning from the power saving mode to the normal mode according to the estimated envelope based on the power saving duration calculated by the duration calculating part.

14. The strike processing method of claim 12, wherein
a particular period after transitioning to the power saving mode is divided into a plurality of divided periods, and
the estimated envelope is set for each of the divided periods.

15. The strike processing method of claim 14, wherein a same duration is set for each of the divided periods.

16. The strike processing method of claim 12, wherein the estimated envelope is expressed by an exponential function.

17. The strike processing method of claim 12, wherein the estimated envelope is expressed by a function based on a monomial or a polynomial.

18. The strike processing method of claim 17, wherein the monomial or the polynomial is obtained by approximating an exponential function.

19. The strike processing method of claim 17, wherein the monomial or the polynomial is obtained by approximating a logarithmic function or a trigonometric function.

20. A non-transitory computer-readable recording medium recording a strike processing program causing a computer to execute a processing related to a strike based on a level of a strike envelope which is an envelope set based on a detected strike signal, the strike processing program causing the computer to further execute:
storing a power saving transition level which is a level of the strike envelope at a time of transitioning from a normal mode to a power saving mode having a power consumption lower than the normal mode;
calculating a level at a time of returning from the power saving mode to the normal mode based on an estimated envelope that is set based on the power saving transition level stored and estimates an envelope set based on the strike signal; and
performing the processing related to the strike based on the level at the time of returning from the power saving mode to the normal mode calculated based on the estimated envelope in a case of returning from the power saving mode to the normal mode.
